(19) United States
(12) Patent Application Publication
(10) Pub. No.: US 2006/0064916 A1
(43) Pub. Date: Mar. 30, 2006

(54) Multi-purpose tool

(76) Inventor: Robert Shiflett, Greenville, FL (US)

Correspondence Address: J. W. GIPPLE, P. O. Box 40513, Washington, DC, 20016, US

(21) Appl. No.: 10/949,651

(22) Filed: Sep. 27, 2004

(51) Int. Cl. A01K 81/00

(52) U.S. Cl. 43/6

(57) ABSTRACT

A multi-purpose tool is described, the tool having a spearhead, a shaft and a javelin head, each of which can function as a tool individually or in combination with each other.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATED-BY-REFERENCE OF MATERIAL SUBMITTED ON A COMPACT DISC

Not Applicable

### BACKGROUND OF THE INVENTION

(1) Field of the Invention

This invention is directed to a multi-purpose tool, the components of which can be used separately or in combination.

Although spears are among the earliest tools used by men for hunting and for fighting, they have not changed much during the ages, because they are so simple and basic. But one inherent disadvantage is the size, generally six feet or more in length. This makes them difficult to transport in a safe and compact manner.

It is therefore an object of the present invention to provide an improved spear, that comprises three basic components, which can be disassembled for more conveniet transport and which can be used separately and in various combinations.

(2) Description of Related Art

Applicant is aware of no prior art directly relevant to the present invention.

### BRIEF SUMMARY OF THE INVENTION

In accordance with the present invention, a multi-purpose tool is provided that has (1) a spear head, (2) a shaft, and (3) a javelin head. Each component is detachable from the other and can be used individually or in various combinations.

### BRIEF DESCRIPTION OF SEVERAL VIEWS OF THE DRAWINGS

FIG. 1 is a top plan view of the spear which is the subject of this patent application.

FIG. 2 is a top plan view of the spear head.

FIG. 3 is a top plan view of the javelin head.

### DETAILED DESCRIPTION OF THE DRAWINGS

Reference will now be made to the preferred embodiment of the invention as illustrated in the accompanying drawings.

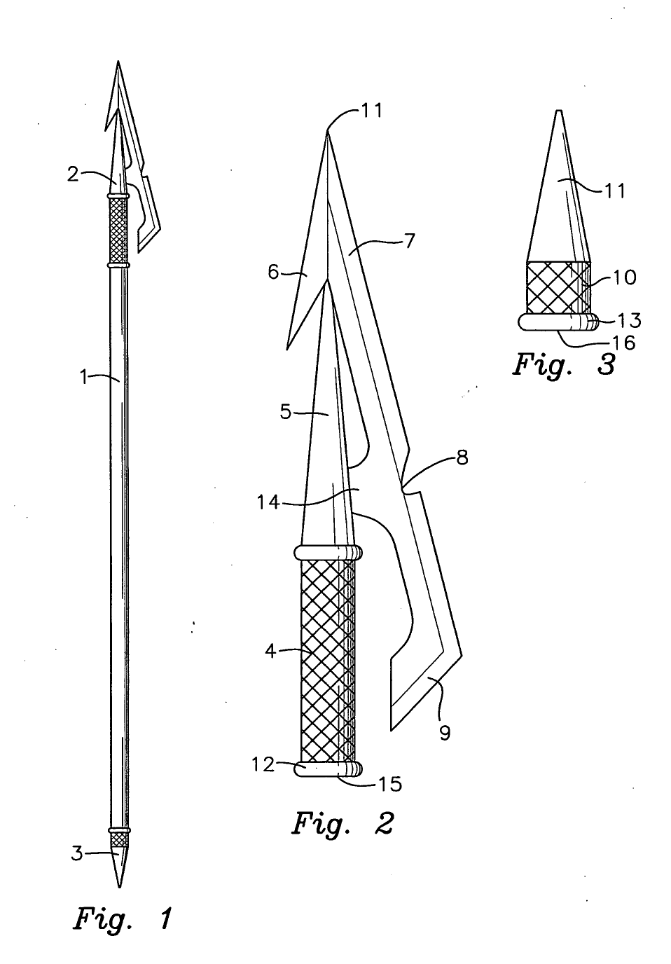

The multi-purpose tool is illustrated in FIG. 1. It comprises a shaft 1, a spearhead 2 and a javelin head 3.

A closer view of the spearhead 2 is seen in FIG. 2. It comprises a spearhead shaft 5, which extends between a handle 4, at one end and a point 17 at the opposite end. The spearhead shaft 5 tapers down from the handle 4 end becoming narrower toward the point 17 end. Extending back from the point 17, on one side is barb 6. Extending back from point 17, on the opposite side is wing 7. Barb 6 and wing 7 are continuous with one another. The outer edges of barb 6 and wing 7 are knife sharp. Wing 7 has a notch 8 and a finial 9. The outer edge of finial 9 is knife sharp. A support strut 14 on the inner edge of wing 7 is attached to spearhead shaft 5. Because of the extended length of wing 7, the support strut 14 is necessary to provide stability to wing 7 and maintain it in a rigid position. The wing 7, including strut 14 and finial 9, has a surface area at least four times that of the barb 6. This provides greater aerodynamic stability to the spearhead.

The surface of handle 4 has crosshatched grooves to provide better grip. At the end of handle 4 opposite spearhead shaft 5, is an upraised hilt 12. A cavity 15 extends through the center of handle 4.

The javelin head 3, as illustrated in FIG. 3, has a point 11 which tapers down from handle 10. The surface of handle 10 has crosshatched grooves to provide better grip. At the end of handle 10 opposite the point 11, is an upraised hilt 13. A cavity 16 extends through the center of handle 10.

When all three components are assembled, as illustrated in FIG. 1, one end of the shaft 1 extends into spearhead cavity 15; and the opposite end extends into cavity 16.

The shaft 1 is a simple pole approximately five feet long and narrow enough to fit snuggly into cavities 15 and 16. The ends of shaft 1 may be threaded to screw into accommodating threads on the inner sides of the cavities 15 and 16.

To facilitate transport in a safe and compact form, the three components (shaft 1), sprearhead 2 and javelin head 3 can be assembled. To make an even more compact form, the shaft may be eliminated from the transport package and improvised in the field. Because shaft 1 is a simple pole, it can be formed from any available source. For instance, a sapling of appropriate size can be felled, de-branched and its ends whittled to fit snuggly within cavities 15 and 16.

The multi-purpose tool, fully assembled as illustrated in FIG. 1 can be used as a spear in hunting or fighting. It can be hurled or thrust into a prey or enemy. The barb 6 ensures that once inserted, the spearhead 2 cannot be easily removed. Because of its length and shape the wing 7 gives aerodynamic stability to the spear when it is hurled from a relatively long distance. It can therefore be thrown with greater accuracy.

The improved gripping surface of handle 4 and notch 8, facilitate dislodging of the spear from prey or enemy.

It will be appreciated that the spearhead 2, by itself is a useful tool. It has a handle 4, for gripping and sharp edges 6 and 7 on its opposite sides. Thus it can be used as a knife, scraper and other such sharp edge tool.

In the fully assembled multi-purpose tool, as illustrated in FIG. 12, the javelin head 3 functions a aerodynamic terminal for the spear, or a means to anchor it in the turf, as may be desirable in positioning it against a charging animal. But, without the spearhead 2, the javelin head 3 and shaft 1 can be used as a javelin or anchored in the turf to function as a flag pole or other such purpose requiring upright stanchion.

It will be further apparent to those skilled in the art that various modifications and variations can be made in the device and method of the present invention without departing from the spirit or scope of the invention. Thus, it is intended that the present invention cover the modifications and variations of this invention provided they come within the scope of the appended claims and their equivalents.

What is claimed is:

1. A multi-purpose tool, comprising:
a spearhead, a shaft, and a javelin head,
said spearhead having a handle portion on one end, a spear point on the other end, and a tapered shaft portion extending between said handle portion and said spear point,
a barb extending back from said spear point on one side of the tapered shaft and a wing extending back from the spear point on the opposite side,
said wing having at least three times the surface area of said barb, and a support strut fixedly connecting it near mid point to the tapered shaft,
said handle portion having a cavity formed through its center, of such proportion as to tightly contain one end of said shaft,
said javelin head having a javelin point on one end, and a handle portion on the opposite end, a cavity formed through the center of said javelin handle portion of such proportion as to tightly contain an end of the shaft opposite the one contained in said spearhead

2. The multi-purpose tool of claim 1 wherein one or both handle portions of said spearhead and said javelin head have grip enhancing surfaces

3. The multi purpose tool of claim 2, wherein said grip enhancing surface are grooves in said surfaces.

4. The multi-purpose tool of claim 1 wherein one or both said handle portions of said spearhead and said javelin head have upraised hilts at their ends opposite their points

5. The multi-purpose tool of claim 1, wherein one or both ends of the said shaft are threaded, so as to accommodate correspondingly similar threaded inner surfaces of the said cavities.
